(19) United States
(12) Patent Application Publication
(10) Pub. No.: US 2014/0274706 A1
(43) Pub. Date: Sep. 18, 2014

(54) COMPOSITIONS AND METHODS FOR INCREASING PHOTOSYNTHESIS

(71) Applicant: Elwha LLC, Bellevue, WA (US)

(72) Inventors: Roderick A. Hyde, Redmond, WA (US); Muriel Y. Ishikawa, Livermore, CA (US); Lowell L. Wood,, JR., Bellevue, WA (US); Victoria Y.H. Wood, Livermore, CA (US)

(21) Appl. No.: 13/836,035

(22) Filed: Mar. 15, 2013

(51) Int. Cl. A01N 61/00

(52) U.S. Cl. CPC A01N 61/00
USPC 504/116.1

(57) ABSTRACT

A composition is provided, where the composition comprises an artificially structured material and an excipient, where the composition is a coating for an organism capable of photosynthesis; and incident light that is photosynthetically active is at least partially transmitted through the composition, whereas incident light that is not photosynthetically active is at least partially absorbed, reflected, emitted, or scattered by the composition. Also provided is an article including an organism, such as a plant, that is coated with any of the compositions described herein and a method for growing an organism capable of photosynthesis by coating the organism with any of the compositions described herein.

### BACKGROUND

The present technology relates generally to compositions and methods for increasing photosynthesis in other organisms, such as plants, that are capable of carrying out the photosynthetic process.

Generally, photosynthesis, also called carbon fixation, is the process by which organisms that undergo photosynthesis utilize light energy to synthesize carbohydrates and other organic molecules from carbon dioxide and water. Carbohydrates and other molecules are synthesized, according to the photosynthetic capacity of the organism, to meet the needs of the growing plant tissues including the woody tissue, leaf tissue, developing flower buds and developing fruit.

The effects of enhanced photosynthesis generally include improved crops and increased yields, e.g., increased fruit size or production (usually measured in weight per hectare or acre), improved color, increased soluble solids, e.g., sugar, acidity, etc., and reduced plant temperature.

Conversely, the effects of a depleted or insufficient photosynthetic capacity generally include diminished crop yields, decreases in productivity, and “excessive fruit drop.” Normal fruit drop occurs when the photosynthetic capacity of the plant is sufficient during the growing season to simultaneously support tree growth, fruit development, and the initiation of flower buds. Excessive fruit drop occurs when photosynthetically derived carbohydrates are in limited supply while fruit is developing. In response, the plant aborts and drops the developing fruit, and limits the initiation of flower buds.

Compositions and methods are needed to maintain or bolster the photosynthetic capacity of plants, increase agricultural yields and the quality of crops, regulate crop temperatures, and reduce the volume of water required to irrigate such crops.

### SUMMARY

The present technology provides compositions and methods for coating an organism that is capable of photosynthesis, such as algae, bacteria, or a plant, where sunlight that is photosynthetically active is at least partially transmitted through the composition to the surface of the organism, and sunlight that is not photosynthetically active is at least partially absorbed, emitted, reflected, or scattered by the composition, away from the surface of the organism. As such, the present technology provides compositions and methods that regulate the quantity and wavelengths of light that reach the coated organism that is capable of photosynthesis. By channeling a greater quantity of sunlight that is photosynthetically active to the surface of the photosynthetic algae, bacteria, plant, or other organism, the present technology can be used to maintain or bolster the photosynthetic capacity of such organisms, increase agricultural yields and the quality of crops.

Further, as the air temperature increases, the present technology can be used to divert sunlight from the surface of an organism that is capable of photosynthesis, such as algae, bacteria, or a plant, to cool the organism. Alternatively, as the air temperature decreases, the present technology can be used to increase thermal radiation towards the surface of a photosynthetically capable organism to warm the organism. Therefore, the present technology may be used, for example, to regulate plant temperature and enhance frost-resistance or heat-resistance of such photosynthetically capable organisms. The present technology may also be used to reduce the volume of water necessary to irrigate said organisms and to improve their drought-resistance.

According to one aspect, the present technology provides a composition, where the composition comprises an artificially structured material and an excipient, wherein the composition is a coating for an organism capable of photosynthesis; and incident light that is photosynthetically active is at least partially transmitted through the composition, whereas incident light that is not photosynthetically active is at least partially absorbed, reflected, emitted, or scattered by the composition.

In some embodiments, the artificially structured material of the compositions may include a metamaterial, multilayer dielectric (MLD)-type reflector, photonic bandgap (PBG) material, liquid crystal, semiconductor, and photochromic dye, etc.

According to another aspect, the present technology provides an article including an organism capable of photosynthesis and a composition, wherein the composition coats at least a portion of the organism's photosynthetically active surface, where the composition is as described herein.

In another aspect, the present technology provides a method for growing such an organism, the method including coating at least a portion of the organism's photosynthetically active surface with a composition, where the composition is as described herein.

The foregoing is a summary and thus by necessity contains simplifications, generalizations and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The skilled artisan will understand that the drawings primarily are for illustrative purposes and are not intended to limit the scope of the inventive subject matter described herein.

FIGS. 1A-1B illustrate, in accordance with an embodiment, a plant with leaves that have been coated by a composition as described herein, where overhead sunlight that is photosynthetically active is at least partially transmitted through the composition and overhead sunlight that is not photosynthetically active is at least partially absorbed, emitted, reflected, or scattered by the composition.

FIG. 2A-2B illustrate, in accordance with an embodiment, a plant with leaves that have been coated by a composition as described herein, where non-overhead sunlight that is photosynthetically active is at least partially transmitted through the composition and non-overhead sunlight that is not photosynthetically active is at least partially absorbed, emitted, reflected, or scattered by the composition.

FIG. 3 illustrates, in accordance with one embodiment, a method for coating a plant with any one of the compositions as described herein.

FIG. 4 illustrates, in accordance with an embodiment, a leaf that has been coated by a composition as described herein, where overhead sunlight that is photosynthetically active is at least partially transmitted through the composition and overhead sunlight that is not photosynthetically active is at least partially absorbed, emitted, reflected, or scattered by the composition.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to FIGS. 1A-1B, in accordance with one embodiment, an illustration is provided of a tree 10 with leaves 12 that have been coated by a composition 20 as described herein. In accordance with one embodiment, the sun 14 in FIGS. 1A-1B is directly over the tree 10 as it would be at approximately noon, the sunlight in FIGS. 1A-1B is relatively intense, substantially all of the sunlight that is photosynthetically active 22 is transmitted through the composition 20 to the surface of the leaf 12, and substantially all of the sunlight that is not photosynthetically active 24 is reflected or scattered away from the surface of the leaf 12 by the composition 20.

Referring to FIGS. 2A-2B, in accordance with one embodiment, an illustration is provided of a tree 10 with leaves 12 that have been coated with a composition 20 as described herein. In accordance with one embodiment, the sun 14 in FIGS. 2A-2B is not directly over the tree 10 as would be so in the morning or late afternoon, the sunlight in FIGS. 1A-1B is relatively mild, substantially all of the sunlight that is photosynthetically active 22 is transmitted through the composition 20 to the surface of the leaf 12, and some of the sunlight that is not photosynthetically active 24 is also transmitted through the composition 20 to the surface of the leaf 12.

Referring to FIG. 3, a flowchart depicts a process 30 for determining the frequency or rate at which a plant is coated with a composition as described herein. A plant is first coated with a composition as described herein, according to one embodiment at a base rate (e.g., once per week, once per month, etc.) (step 32). The plant's rate of photosynthesis (step 33), water consumption (step 35), and temperature (step 37) are monitored. The frequency of coating is increased if the plant's rate of photosynthesis has not increased, the amount of water that is consumed by the plant has not decreased, or the plant's temperature has not decreased (step 38). The frequency of coating is maintained if the plant's rate of photosynthesis has increased, the amount of water that is consumed by the plant has decreased, or the plant's temperature has decreased (step 39).

Referring to FIG. 4, in accordance with an embodiment, an illustration is provided of a leaf that has been coated by a composition as described herein, where overhead sunlight that is photosynthetically active (41) is at least partially transmitted through the composition and overhead sunlight that is not photosynthetically active is at least partially reflected at the surface (42), reflected volumetrically (43), absorbed (44), emitted (45), or scattered (46) by the composition.

The technology is described herein using several definitions, as set forth throughout the specification.

The use of the terms “a” and “an” and “the” and similar referents in the context of describing the elements (especially in the context of the following claims) are to be construed to cover both the singular and the plural, unless otherwise indicated herein or clearly contradicted by context.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The present technology relates generally to compositions and methods for increasing photosynthesis in organisms capable of photosynthetic activity. As used herein, the term “organism capable of photosynthesis” includes any plant or organism capable of synthesizing complex organic material utilizing, but not limited to, carbon dioxide, water, inorganic salts, and light energy captured by light-absorbing pigments, such as but not limited to chlorophyll and other accessory pigments. Such photosynthetic organisms are called photoautotrophs, and include plants, algae and certain bacteria. Photoautotrophs are organisms that are able to create their own food using light energy directly from inorganic compounds.

In some embodiments, the photosynthetic process consists of light reactions and dark reactions, whereby carbon dioxide (CO₂), water (H₂O), and light energy are used to synthesize an energy-rich carbohydrate. In a general case, the carbohydrate produced is glucose (C₆H₁₂O₆), with an oxygen by-product.

Pigments are chemical compounds which reflect only certain wavelengths of visible light. Pigments can reflect light and can absorb certain wavelengths. The ability to absorb only certain wavelengths of light is useful to plants and other autotrophs that make their food using photosynthesis. Plants, algae, and cyanobacteria use pigments as the means by which the light energy is captured for photosynthesis. Each pigment reacts with a specific narrow range of the electromagnetic spectrum; thus, a photosynthetic organism may produce several different pigments in order to increase its light energy capture.

As used herein, the term “chlorophyll” is used to describe a biomolecule that is critical in photosynthesis, and which allows organisms to absorb energy from light. Chlorophyll absorbs light most strongly in the blue portion, and to a lesser degree, in the red portion of the electromagnetic spectrum. The green color of chlorophyll is due to the biomolecule's poor absorption of green and near-green light. Chlorophyll is structurally similar and produced through the same metabolic pathway as other porphyrin pigments such as heme, an iron compound of protoporphyrin constituting the pigmental or protein-free part of the hemoglobin molecule, responsible for the molecule's oxygen-carrying properties. The most widely distributed form that occurs in terrestrial plants is chlorophyll a. Chlorophyll f is present in cyanobacteria and other oxygenic microorganisms that form stromatolites. Stromatolites are layered accretionary structures formed through the trapping, binding and cementation of sedimentary grains by micro-organism biofilms, in particular by cyanobacteria, also commonly known as blue green algae.

Table 1 lists representative chlorophyll structures.

TABLE 1

| | | | Chlorophyll | Chlorophyll | | |
|---|---|---|---|---|---|---|
| | Chlorophyll a | Chlorophyll b | c1 | c2 | Chlorophyll d | Chlorophyll f |
| Mol. | C₅₅H₇₂O₅N | C₅₅H₇₀O₆N₄ | C₃₅H₃₀O₅N₄ | C₃₅H₂₈O₅N₄ | C₅₄H₇₀O₆N₄ | C₅₅H₇₀O₆N₄ |
| Formula | ₄Mg | Mg | Mg | Mg | Mg | Mg |
| C2 group | —CH₃ | —CH₃ | —CH₃ | —CH₃ | —CH₃ | —CHO |
| C3 group | —CH═CH₂ | —CH═CH₂ | —CH═CH₂ | —CH═CH₂ | —CHO | —CH═CH₂ |
| C7 group | —CH₃ | —CHO | —CH₃ | —CH₃ | —CH₃ | —CH₃ |
| C8 group | —CH₂CH₃ | —CH₂CH₃ | —CH₂CH₃ | —CH═CH₂ | —CH₂CH₃ | —CH₂CH₃ |
| C17 group | CH₂CH₂COO- | CH₂CH₂COO- | CH═CHCOOH | CH═CHCOOH | CH₂CH₂COO- | CH₂CH₂COO- |
| | Phytyl | Phytyl | | | Phytyl | Phytyl |
| C17-C18 | Single | Single | Double | Double | Single | Single |
| bond | (chlorin) | (chlorin) | (porphyrin) | (porphyrin) | (chlorin) | (chlorin) |
| Occurrence | Universal | Mostly | Various | Various | Cyano | Cyano |
| | | plants | algae | algae | bacteria | bacteria |

For example, Chlorophyll a is a specific form of chlorophyll that is used in oxygenic photosynthesis, and absorbs the most energy at violet-blue and orange-red light wavelengths. Chlorophyll a is essential for photosynthesis in eukaryotes, cyanobacteria and prochlorophytes due to its role as a primary electron donor in the electron transport chain. Chlorophyll b is yellow in color, and primarily is an absorber of blue light.

Chlorophyll c is found in certain marine algae such as diatoms and dinoflagellates. The golden or brownish color of Chlorophyll c₁ comes from an accessory pigment.

Chlorophyll d is present in marine red algae and cyanobacteria, and absorbs far infrared wavelength light (710 nm), just outside of the visible range of the electromagnetic spectrum. Organisms containing chlorophyll d most likely live in an environment without plentiful visible light, such as occurs in moderately deep water; these organisms have adapted to using the far red light portion of the light spectrum for photosynthetic processes.

As used herein, photosynthesis frequently occurs in plastids within the photosynthetic organism, such as chloroplasts in plants. Plastids are membrane-bound organelles containing photosynthetic pigments such as chlorophyll, situated within an organism's cells.

An example where photosynthesis does not occur in plastids exists in cyanobacteria, wherein photosynthesis occurs instead in the thylakoid membranes in the cyanobactrium cytoplasm and not in plastids. Organisms such as cyanobacteria are capable of photosynthetic activity but do not contain plastids.

In some photosynthetic organisms, water (H₂O) is not utilized in the photosynthetic process, and therefore oxygen is not a by-product of the organism's photosynthetic process. Examples of organisms that do not utilize water or produce oxygen are green sulfur (S) and purple S bacteria, which utilize hydrogen sulfide (H₂S) instead of water, producing sulfur as their photosynthetic by-product.

In the case of purple S bacteria, the photosynthetic pigment is bacteriochlorophyll a or b, and carotenoids. In purple S bacteria, H₂S, sulfur, thiosulfate, molecular hydrogen and organic compounds act as electron donors. All purple S bacteria also fix nitrogen through their photosynthetic process.

In the case of green S bacteria, the photosynthetic pigments are bacteriochlorophylls c, d or e, carotenoids chlorobactene, hydrochlorobactene, isorenieratene and β-isorenieratene.

Similarly to green S bacteria, green nonsulfur (nonS) bacteria contain bacteriochlorophyll c or d as major and minor pigments, but these differ from green S bacteria in their structure, nutrition, metabolism and ecology. Green nonS bacteria are photoheterotrophs, facultative photoautotrophs or chemoheterotrophs; they may be found growing in hot springs, for example. Such nonS bacteria derive organic nutrients from cyanobacteria, and are always found in association with cyanobacteria.

In some embodiments, an organism that is capable of photosynthesis is contacted with any of the compositions or according to any of the methods described herein, where the organism is one other than plants, bacteria and algae. For example, the Oriental Hornet has similar capabilities to plants regarding photosynthesis. However, the Oriental Hornet utilizes the xanthopterin pigment, not chlorophyll. Xanthopterin acts as a light harvesting molecule in transforming light energy into electrical energy.

Algae, bacteria, plants, and possible higher organisms as described herein may be collected and processed into a feedstuff (i.e., any edible substance that is ingestible by any animal such as grains, fruits, flowers, tubers, roots, vegetables, proteins, leaves, grasses etc.) or feedstock (i.e., any chemical or polymer feedstock used for industrial purposes such as hydrocarbons, sugars, alcohols, peptides, proteins, natural rubber, synthetics, bioethanol, biodiesel, biomass) or non-food crops used in a natural state (i.e., any non-food crop used for use as fuel, furniture, jewelry, perfumes, ornamental plants, or floriculture such as roses).

An example of a bacteria used as a feedstuff is Spirulina, a type of cyanobacteria commonly sold as a nutritional supplement.

Examples of algal feedstuff are types of seaweed, such as Porphyra, a foliose red algae eaten dried in food products such as layer or nori, and in other commonly consumed formats; the single celled algae, Chlorella, is used for fuel and food. Dried chlorella is approximately 45% protein, 20% fat, 20% carbohydrate, 5% fibre, and 10% minerals and vitamins, and is a valuable foodstuff abundant in calories, vitamins and fat.

As used herein, the term “plant” refers to any green plant having chloroplasts for photosynthetic reactions. In some embodiments, the plant includes fruiting, agricultural, and ornamental crops and the products thereof, including those selected from the group consisting of fruits, vegetables, trees, shrubs, flowers, grasses, roots, seeds, landscape plants, ornamental plants, agricultural plants and adornments and floriculture such as roses.

The plants described herein include agricultural plants of which a part or all is harvested or cultivated on a commercial scale or which serve as an important source of a feedstuff or feedstock as described above, fibers (e.g., cotton, linen), combustibles (e.g., wood) or other chemical compounds. Agricultural plants also encompass horticultural plants, i.e., plants grown in gardens (and not in fields), such as certain fruits and vegetables. Agricultural plants further include floricultural plants such as flowering plants, household plants, ornamental plants, or any such adornment-producing plant.

Examples of agricultural plants that are used as feedstuff or feedstock include soybean, corn (maize), wheat, triticale, barley, oats, rye, rape, such as canola/oilseed rape, millet (sorghum), rice, sunflower, cotton, sugar beets, pome fruit, citrus, bananas, strawberries, blueberries, almonds, grapes, mango, papaya, peanuts, potatoes, tomatoes, peppers, cucurbits, cucumbers, melons, watermelons, garlic, onions, carrots, cabbage, beans, peas, lentils, alfalfa, trefoil, clovers, flax, herbs, grasses, lotus, lettuce, sugar cane, apples, tea, tobacco and coffee.

As used herein, the term “light that is photosynthetically active” is meant to encompass wavelengths of light approximately between about 400-750 nm.

As used herein, the term “light that is not photosynthetically active” is meant to encompass wavelengths of light that are roughly not between about 400-750 nm. For example, light that is not photosynthetically active generally includes light having wavelengths between about 300-400 nm (near ultra violet, NUV, band), between about 750 nm-1400 nm (the near infrared, NIR, band), and between about 1400-3000 nm (short-wave infrared, SWIR, band). In some embodiments, the compositions described herein convert sunlight that is not photosynthetically active into light that is photosynthetically active. For example, light having wavelengths between 300-400 nm, that is not photosynthetically active, can be at least partially absorbed by the compositions described herein, and light having wavelengths between 400-750 nm, that is photosynthetically active, may be subsequently fluoresced by the compositions described herein.

As used herein, the term “black body radiation” represents the upper limit to the amount of thermally induced radiation that a material may emit at a given temperature.

As used herein, a basic type of interaction between radiation (light) and matter is described by a photon transferring all of its energy to an atom or molecule. The energy of the photon raises an electron to a higher energy level or, in the case of a molecule, raises the molecule to a higher rotational or vibrational state. This increase in energy state of an atom or molecule may be reversed through scattering, emission, fluorescence or phosphorescence. For purposes herein, a molecule that has absorbed the energy of a photon is referred to as an “activated” molecule.

As used herein, the term “emit” is a measure of how strongly a body radiates at a given wavelength. One way to describe emission is as a mechanism by which molecular kinetic energy (thermal energy) may be converted into photons. Molecules may be activated by collisions with each other and the released energy emitted as photons.

As used herein, the term “absorb” refers to the light-absorbing ability of the compositions and materials described herein. The “absorption coefficient” of the compositions and materials described herein expresses how far light of a particular wavelength may penetrate into the compositions and materials described herein before being absorbed. For example, in compositions and materials with a low absorption coefficient, light is poorly absorbed, and if the material is thin enough, it will appear transparent to that wavelength. The absorption coefficient depends on the compositions and materials, and on the wavelength of light which is being absorbed.

As used herein, for a body in thermodynamic equilibrium, the amount of thermal energy emitted equals the energy absorbed.

As used herein, the term “scatter” refers to light that has been redirected and which exhibits diminished amplitude or intensity. A dissipation coefficient describes extent to which the amplitude or intensity of light diminishes, by scattering, upon the transmission of light through a given thickness of a scattering medium (e.g., fog). Scattering describes the mechanism for energy release in which the molecule may spontaneously transition back to its original state by emitting a photon identical to that absorbed; the photon remains part of the radiation field but its direction of propagation is diffused.

As used herein, the term “reflect,” refers to light that has been redirected and which maintains substantially all of its amplitude or intensity. A reflection coefficient describes either the amplitude or the intensity of a reflected wave relative to an incident wave, and quantifies the proportion of energy that is reflected. Specular reflection is scattering in which the photon's direction of propagation is changed, but not diffused. Examples of good reflectors are polished metals; polished metals such as nickel, gold and aluminum are superior infrared reflectors.

As used herein, the term “transmit” refers to light that substantially passes through a composition or material as described herein. A transmission coefficient of a composition or material is a measure of how much of an electromagnetic wave passes through the composition or material. Transmission coefficients can be calculated from the ratio of light that passes through a composition or material relative to the light that initially contacted the composition or material. Few materials transmit light efficiently in the infrared between 7-14 microns. One of the few good transmitters of infrared light is germanium.

As used herein, the term “excipient” refers to an inactive substance used as a carrier for the “active” parts of the composition. For example, in a pharmacological application, an “active” substance (such as acetylsalicylic acid) is not easily administered and absorbed by the human body; in such cases the substance in question may be dissolved into or mixed with an excipient to aid in the active substance's administration and absorption by the organism. In another example, once an active ingredient has been purified, it may not be able to stay in a purified form for a long period of time before denaturing, falling out of solution, sticking to the sides of its holding vessel, or otherwise degrading in composition. In order to stabilize an active ingredient, excipients are added to ensure that the active ingredient will remain “active”. It is often necessary for the active ingredient to stay in a stable form for a sufficient period of time to ensure that the shelf-life of the product is competitive with other products. In the embodiment of the composition discussed herein, the excipient may take the form of a carrier, a binder, a base or a similar material that contains, holds, binds or cements the artificially structured material. In an embodiment discussed herein, for example, the excipient and the artificially structured material may comprise the same entity, such as in an optical chaff. In an embodiment, the excipient is selected from the group consisting of an adhesive agent, fungicide, antibiotic, pesticide, plant nutrient, antifreeze agent, particulate material, surfactant, dispersant, a wetting agent, a marking agent, and a combination thereof.

In an embodiment, a marking agent can be included to aid the user in detecting the presence or amount of coating on the organism. The marking agent can be detected due to its optical properties (e.g., narrow spectral band), magnetic properties, or it can comprise an odorant. In an embodiment, detecting (or failing to detect) the presence or amount of a coating (e.g., via a marking agent) can lead to delivering a second coating (e.g., if insufficient coating is present).

Embodiments of “artificially structured material” may include one or more of a metamaterial, multilayer dielectric (MLD)-type reflector, photonic bandgap (PBG) material, liquid crystal, semiconductor, and photochromic dye.

As used herein, a “metamaterial” generally features subwavelength elements, i.e., structural elements with portions having electromagnetic length scales smaller than an operating wavelength of the metamaterial, and the subwavelength elements have a collective response to electromagnetic radiation that corresponds to an effective continuous medium response, characterized by an effective permittivity, an effective permeability, an effective magnetoelectric coefficient, or any combination thereof.

Some exemplary metamaterials are described by J. A. Bowers et al., in published U.S. patent application No. 20120019892; R. A. Hyde et al., “Variable metamaterial apparatus,” U.S. patent application Ser. No. 11/355,493; D. Smith et al., “Metamaterials,” International Application No. PCT/US2005/026052; D. Smith et al., “Metamaterials and negative refractive index,” Science 305, 788 (2004); D. Smith et al., “Indefinite materials,” U.S. patent application Ser. No. 10/525,191; C. Caloz and T. Itoh, Electromagnetic Metamaterials: Transmission Line Theory and Microwave Applications, Wiley-Interscience, 2006; N. Engheta and R. W. Ziolkowski, eds., Metamaterials: Physics and Engineering Explorations, Wiley-Interscience, 2006; and A. K. Sarychev and V. M. Shalaev, Electrodynamics of Metamaterials, World Scientific, 2007.

In some embodiments a metamaterial may include a layered structure. For example, embodiments may provide a structure having a succession of adjacent layers, where the layers have a corresponding succession of material properties that include electromagnetic properties (such as permittivity and/or permeability). The succession of adjacent layers may be an alternating or repeating succession of adjacent layers, e.g., a stack of layers of a first type interleaved with layers of a second type, or a stack that repeats a sequence of three or more types of layers. When the layers are sufficiently thin (e.g., having thicknesses smaller than an operating wavelength of the metamaterial), the layered structure may be characterized as an effective continuous medium having effective constitutive parameters that relate to the electromagnetic properties of the individual layers.

Additional metamaterials having a positive permittivity include but are not limited to: semiconductors (e.g., at frequencies higher than a plasma frequency of the semiconductor) and insulators such as dielectric crystals (e.g., silicon oxide, aluminum oxide, calcium fluoride, magnesium fluoride), glasses, ceramics, and polymers (e.g., photoresist, PMMA). In some embodiments a positive permittivity material is a gain medium. Examples of gain media include semiconductor laser materials (e.g., GaN, AlGaAs), doped insulator laser materials (e.g., rare-earth doped crystals, glasses, or ceramics), and Raman gain materials. Materials having a negative permeability include but are not limited to: ferrites, magnetic garnets or spinels, artificial ferrites, and other ferromagnetic or ferrimagnetic materials. Materials having a negative permittivity include but are not limited to: metals (e.g., at frequencies less than a plasma frequency of the metal) including the noble metals (Cu, Au, Ag); semiconductors (e.g., at frequencies less than a plasma frequency of the semiconductor); and polar crystals (e.g., SiC, LiTaO₃, LiF, ZnSe) at frequencies within a restrahlen band of the polar crystal (G. Schvets, “Photonic approach to making a material with a negative index of refraction,” Phys. Rev. B 67, 035109 (2003) and T. Tauber et al., “Near-field microscopy through a SiC superlens,” Science 313, 1595 (2006).

As used herein, the term “multilayer dielectric (MLD)-type reflector” refers to an optical layer or coating that is generally constructed of optical repeating units that form the basic building blocks of a dielectric stack. The optical repeating units typically include two or more layers of at least a high and a low refractive index material. A multilayer reflector can be designed, using these building blocks, to reflect infrared, visible or ultraviolet wavelengths. In general, the stack can be constructed to reflect light of a particular wavelength by controlling the optical thickness of the layers. Exemplary MLD type reflectors are described in published U.S. patent application No. 20060290844, published PCT Patent Application WO 95/17303, and U.S. Pat. No. 6,531,230.

In certain embodiments, the MLD-type reflector includes a stack of inorganic materials. Some suitable materials used for the low refractive index material include SiO₂, MgF₂ and CaF₂ and the like. Some suitable materials used for the high refractive index material include TiO₂, Ta₂O₅, ZnSe and the like. The composition, thickness, and number of these reflectors can be tailored to tune the reflectivity and transmissivity of the reflector. Reflection coefficients of the reflector can be reduced to less than 0.2%, for example, producing an antireflection dielectric coating. Conversely, the reflectivity can be increased to greater than 99.99%, for example, producing a high-reflector dielectric coating. The level of reflectivity can also be tuned to any particular value, for instance, to produce a reflector that reflects 90% and transmits 10% of the light that falls on it, over some range of wavelengths. In some embodiments, the MLD-type reflector has a nonperiodic structure. In some embodiments, the MLD-type reflector has a crystalline structure.

As used herein, the terms “photonic bandgap (PBG) material” and “stacked PBG material,” are used to describe materials including photonic crystals, which are composed of periodic dielectric or metallo-dielectric nanostructures that affect the propagation of electromagnetic waves in a similar way as the periodic potential in a semiconductor crystal affects the electron motion by defining allowed and forbidden electronic energy bands. Generally, photonic crystals contain regularly repeating internal regions of high and low dielectric constant. The photonic bandgap material (PBG) may comprise a multi-layer structure varying in at least one of one, two, or three dimensions. Exemplary photonic crystal and PBG materials may include, for example, silicon, selenium, germanium, diamond, zinc oxide, boron nitride, gallium nitride, graphene, and zinc telluride. Photons of light propagate through this structure, or not, depending on their wavelength. Wavelengths of light that are allowed to travel are known as modes, and groups of allowed modes form bands. Disallowed bands of wavelengths are called photonic “band gaps.” In some cases, band gaps may be limited to certain polarizations or photon directions. Since the basic physical phenomenon is based on diffraction, the periodicity of the photonic crystal structure has to be of the same length-scale as half the wavelength of the electromagnetic waves, i.e., ˜350 nm (blue) to 700 nm (red) for photonic crystals operating in the visible part of the spectrum. In an embodiment, the PBG material has a bandgap of between about 1.0 ev and 1.5 eV. In an embodiment, the PBG material absorbs, reflects, emits, or scatters light having wavelengths between 750-3000 nm.

As used herein, the term “semiconductor” refers to a material with electrical conductivity intermediate in magnitude between that of a conductor and an insulator. Silicon is used to create most semiconductors commercially. Common semiconducting materials include crystalline solids, chips, amorphous materials, and liquids. Other materials may be used, including germanium, gallium arsenide, silicon carbide, diamond, titanium dioxide, and copper dioxide. A pure semiconductor is often called an “intrinsic” semiconductor. The electronic properties and the conductivity of a semiconductor may be changed in a controlled manner by adding very small quantities of other elements, called “dopants”, to the intrinsic material. In crystalline silicon typically this is achieved by adding impurities of boron or phosphorus to the melt and then allowing it to solidify into the crystal. This process is called “doping” and the semiconductor is “extrinsic.” By alloying multiple compounds in ternary, quaternary, or even quinary compositions, some semiconductor materials may be made tunable. Materials that are transparent to the generated wavelength of light are advantageous, as this allows for more efficient extraction of photons from the bulk of the material. In such transparent materials, light production is not limited to the surface. Index of refraction is also composition-dependent and influences the extraction efficiency of photons from the material.

A semiconductor is characterized by a valence band that is filled or almost filled by electrons and another energy band called a conduction band that is separated in energy by an amount, E_{g}, the band gap, from the upper edge of the valence band. With light incident on semiconductor material, the electrons near the upper edge of the valence band may be excited to the conduction band provided that the photon energy is sufficient to match or exceed the energy gap, E_{g}. By alloying multiple compounds in ternary, quaternary, or even quinary compositions, some semiconductor materials may be made tunable. Materials that are transparent to the generated wavelength of light are advantageous, as this allows for more efficient extraction of photons from the bulk of the material. In such transparent materials, light production is not limited to the surface. Index of refraction is also composition-dependent and influences the extraction efficiency of photons from the material.

Particularly of interest are semiconductors that have an optical bandgap. Examples of optical bandgap semiconductors include semiconductors containing silicon, selenium, germanium, and compounds of gallium, silicon, aluminum, zinc, indium, cadmium, lead, tantalum, iron, copper and their compounds. These types of semiconductors are found in solar cells, which use the Shockley-Queisser limit, as it is known to the skilled artisan, to determine the maximum possible efficiency of a single junction solar cell under un-concentrated sunlight, as a function of the semiconductor bandgap. If the bandgap is too high, most daylight photons cannot be absorbed; if it is too low, then most photons have much more energy than necessary to excite electrons across the bandgap, and the rest is wasted. Examples of semiconductors that have optical bandgaps include silicon (Si) at 1.11 eV, and cadmium telluride (CdTd) at 1.44 eV. In an embodiment, the semiconductor absorbs, reflects, emits, or scatters light having wavelengths between 750-3000 nm.

As used herein, the terms “liquid crystal” and “liquid crystalline particle” are meant to describe a state of matter that has some properties of a conventional liquid and others of a solid crystal. For instance, a liquid crystal may flow like a liquid, but its molecules may be oriented in a crystal-like way. In an embodiment, the liquid crystal comprises a cholesteryl nonanoate compound, cyanobiphenyl compound, or a combination thereof. Liquid crystals include thermotropic and lyotropic liquid crystals. Thermotropic liquid crystals exhibit a phase transition, at a “phase transition temperature” or within a “phase transition temperature range,” into a liquid crystal phase. In an embodiment, the liquid crystal has a phase transition temperature of about 0° C. to about 50° C., or of about 20° C. to about 30° C. Lyotropic liquid crystals exhibit phase transitions as a function of both temperature and concentration of the liquid crystals relative to a substrate.

In some embodiments, liquid crystals include thermochromic compounds or materials that reversibly change color due to a change in temperature. Typically, thermochromic materials display a reversible change of color at a specific temperature or temperature range. In some embodiments, the compositions and materials described herein can include a thermochromic material in an amount of about 0.01 wt. % to about 1 wt. %, about 1 wt. % to about 5 wt. %, about 5 wt. % to about 10 wt. %, about 10 wt. % to about 25 wt. %, or a range between and including any two of these values.

As used herein, the terms “photochromic” or “photochromic dye” are meant to describe compounds and materials that exhibit photochromism, which is the reversible transformation of a chemical species between two forms by the absorption of electromagnetic radiation, where the two forms have different absorption spectra. Typically, photochromic dyes display a reversible change of color upon exposure to light, as exemplified below.

[chemical structure]

Classes of photochromic dyes include the spiropyrans, spirooxazines (e.g., leucodye), diarylethenes (e.g., stilbene, dithienylethenes, as shown above), azobenzenes, fulgides, photochromic quinones (e.g., phenoxynaphthacene quinone), and silver salts (e.g., silver chloride). Leuco dyes may be both photochromic and thermochromic. The time required for a photochromic dye to complete its reversible transformation from a first chemical species to a second chemical species and back to the first chemical species is referred to as the “switch-back time.” In an embodiment, the photochromic dye has a switch-back time of about 500 to about 1,500 seconds. In an embodiment, the photochromic dye has a switch-back time of about 900 to about 1,100 seconds. In some embodiments, the photochromic dye undergoes a permanent color (e.g., photo-reactive or photo-changeable) change upon exposure to ultraviolet or visible light radiation. The amount of light absorbed by the photochromic dye can be referred to as the quantum yield of the photochromic dye. In some embodiments, the quantum yield of the dye will be fixed. In some embodiments, the quantum yield of the dye will vary depending upon environmental conditions. In some embodiments, the photochromic dye can revert between thermodynamic forms or isomers under certain conditions. Exemplary photochromic dyes are described in the published U.S. Patent Application No. 20050066453. In some embodiments, the compositions and materials described herein can include a photochromic material in an amount of about 0.01 wt. % to about 1 wt. %, about 1 wt. % to about 5 wt. %, about 5 wt. % to about 10 wt. %, about 10 wt. % to about 25 wt. %, or a range between and including any two of these values.

In an embodiment, the photochromic dye comprises a spiropyran, spirooxazine, triarylmethane, diarylethene, azobenzene, silver salt, stilbene, azastilbene, nitrone, fulgide, naphthopyran (e.g., 2H-naphthopyran or 3H-naphthopyran), quinone, anthrocyanin, or a combination thereof. Among the organic photochromic dyes, synthetic anthocyanin 20-hydroxy-4′ (HMC) has the same molecular skeleton as plant pigments. (See J. Jpn. Soc. Colour Mater., 83 (7), 289-294. It is believed that HMC is safe for human health with potentially low environmental impact.

In one aspect, a composition is provided, where the composition comprises an artificially structured material and an excipient, wherein the composition is a coating for an organism capable of photosynthesis; and incident light that is photosynthetically active is at least partially transmitted through the composition, whereas incident light that is not photosynthetically active is at least partially absorbed, reflected, emitted, or scattered by the composition.

In some embodiments of the composition, the coating is configured to reduce photodamage to the organism. In some embodiments, the coating is configured to absorb incident near-UV photons in a radiationless mode. In some embodiments, the coating is configured to reduce thermoaquatic stress to the organism. In some embodiments, the coating is configured to absorb incident near-UV photons and fluoresce light that is photosynthetically active. In some embodiments, the coating is configured to scatter or fluoresce near-infrared (NIR) photons. In some embodiments, the coating is configured to absorb incident low-infrared non-reflected light. In some embodiments, the coating is configured to modify NIR absorption over a normal value for the organism. In some embodiments, the coating is configured to reflect incident light from a surface of the coating and/or by volumetric scattering within the coating.

In some embodiments of the composition, the coating comprises at least one optical property that is temperature sensitive. In some embodiments, the coating is configured to thermostat the organism's surface temperature. In some embodiments, the coating is configured to absorb light that is not photosynthetically active at one temperature, and scatter or fluoresce light that is not photosynthetically active at a higher temperature. In some embodiments, the coating is configured to reflect or scatter an increasing proportion of light that is not photosynthetically active as the temperature of the coating increases and absorb a decreasing proportion of light that is not photosynthetically active as the temperature of the coating increases.

In some embodiments of the composition, the coating is configured to protect the organism from heat related damage or stress. In some embodiments, the coating comprises an optical chaff that is configured to increase radiative cooling of the organism. In some embodiments, the coating is configured to increase thermal emissivity in the LWIR above the normal value for the organism.

In some embodiments of the composition, the artificially-structured material is configured to modify LWIR emissivity over the normal value of the organism. In some embodiments, the artificially structured material is radiation flux-sensitive.

In an embodiment, the artificially structured material is configured to thermostat the organism surface temperature by preferentially absorbing light in non-photosynthetically active spectral bands at lower coating temperatures, and differentially scattering-or-fluorescing such light at higher coating temperatures.

In an embodiment, the reflectivity and/or scattering of the coating for at least a portion of the non-photosynthetically active spectrum is configured to increase with temperature while the coating's corresponding absorption decreases with temperature. In one example, the increase in reflectivity and/or scattering may be a smooth transition. In another example, the increase in reflectivity and/or scattering may be an abrupt transition.

In an embodiment, the coating is configured to protect underlying organism tissue from heating above normal range, thereby differentially-reducing thermo-aquatic stress on the tissue. An embodiment would be materials that absorb the infrared radiation preventing it from reaching the surface of the organism. Such a material may either help cool by trapping IR radiation before it reaches the surface of the organism and then radiating the radiation away, or warm the organism, by trapping the infrared energy and converting it to thermal energy to warm the organism. Examples of good infrared absorbers are plastics, ceramics and textiles.

In an embodiment, the coating comprises optical chaff configured to increase radiative cooling of the underlying organism. The optical chaff may have one-, two-, and three-dimensional artificial structures on its surfaces.

In an embodiment, the radiative properties of the artificially structured material(s) may shift significantly when the temperature and/or photoflux changes (such as takes place at sunrise or sunset). In one example, the material's radiative properties would be chosen so that the temperature of the surface of the organism would drop during the night-time.

As used herein, the term “adhesive agent” refers to a liquid or solid material that improves the adhesion of the compositions, materials, and articles described herein (e.g., a powder, film, fabric, dye, crystal, or coating) to a plant. Adhesive agents can be mixed with liquid crystalline particles, MLD reflector particles, or hydrophilic particles to aid in spraying uniform treatments on a plant or horticultural substrate. Non-limiting adhesive agents include, for example, modified phthalic glycerol alkyd resins such as Latron B-1956 from Rohm & Haas Co.; plant oil based materials (cocodithalymide) with emulsifiers; polymeric terpenes; nonionic detergents (ethoxylated tall oil fatty acids); guar gum; xanthane gum, latex, agar, starch, epoxide derivatives (e.g., EP30HT® sold by Masterbond, Inc., Hackensack, N.J.), non-petroleum based adhesive resins, biodegradable resins, milk-based glues, and the like. The adhesive agent is generally non-toxic and may have high optical clarity and temperature resistance.

Exemplary non-limiting fungicides include, but are not limited to, copper chelate, which is used to treat ash yellows, Dutch elm disease and fruit tree-related fungus problems; mefenoxam ((R)-2[(2,6-dimethylphenyl)-metho-xyacetylamino]-propionic acid methyl ester), which is used to treat certain plant diseases in nonbearing citrus, nonbearing deciduous fruits and nuts, ornamentals, and shade trees; propiconazole, which is used to treat broad spectrum systemic disease control; and others. The amount of adhesive agent in the composition can be from about 0.1 wt. % to about 5 wt. %, from about 5 wt. %, to about 10 wt. %, from about 10 wt. %, to about 25 wt. %, from about 25 wt. % to about 50 wt. %, or a range between and including any two of these values.

Exemplary non-limiting antibiotics include, but are not limited to oxytetracycline and streptomycin. The amount of antibiotics in the composition can be from about 0.001 wt. % to about 0.01 wt. %, from about 0.01 wt. %, to about 0.1 wt. %, from about 0.1 wt. %, to about 1 wt. %, from about 1 wt. %, to about 10 wt. %, or a range between and including any two of these values.

Exemplary non-limiting pesticides include, but are not limited to, abamectin B1, which is used for insect pest control for woody trees and shrubs for beetles, lace bugs, spider mites and leaf miners; imidacloprid, which is used for broad spectrum control for adelgid, armored scales, Asian longhorned beetle, aphids, elm leaf beetles, black vine weevil larvae, eucalyptus longhorned borer, flatheaded borers (including bronze birch borer and alder-birch borer), Japanese beetles, lace bugs, leaf hoppers, leaf miners, mealy bugs, sawfly larvae, pine tip moth larvae, psyllids, royal palm bugs, scale insects, thrips (suppression) and whiteflies; azadirachtin, which is used for insect pest control for aphids, armyworms, bagworms, beetles, grubs and weevils, cankerworms, caterpillars, loopers and moths, chafers, cutworms, flies, greenhouse leaf tiers, leaf hoppers, leaf miners, leaf rollers, leaf perforators, marsh crane flies, mealy bugs, psyllids, sawflies, thrips and whiteflies; and nicotine sulfate, which is used for control of mites. The amount of pesticides in the composition can be from about 0.001 wt. % to about 0.01 wt. %, from about 0.01 wt. %, to about 0.1 wt. %, from about 0.1 wt. %, to about 1 wt. %, from about 1 wt. %, to about 10 wt. %, or a range between and including any two of these values.

Non limiting plant nutrients include, for example, nitrogen, magnesium, calcium, boron, potassium, copper, iron, phosphorus, manganese, zinc, and salts thereof. The amount of nutrients in the composition can be from about 0.001 wt. % to about 0.01 wt. %, from about 0.01 wt. %, to about 0.1 wt. %, from about 0.1 wt. %, to about 1 wt. %, from about 1 wt. %, to about 10 wt. %, or a range between and including any two of these values.

Suitable for use as antifreeze agents are, in principle, all substances which lower the melting point of water. Suitable antifreeze agents include alkanols, such as methanol, ethanol, isopropanol, the butanols, glycol, glycerol, diethylene glycol and the like.

In some embodiments, particulate materials or particulate carriers, including hydrophilic particles, are used to help the composition adhere to the plant. Non limiting particulate materials include, for example, chaff, calcined calcium carbonate, calcined talc, calcined kaolin, baked kaolin, fired kaolin, metakaolin, calcined bentonites, calcined clays, calcined pyrophyllite, SiO₂, calcined silica, calcined feldspar, calcined sand, calcined quartz, calcined chalk, calcined limestone, calcined precipitated calcium carbonate, baked calcium carbonate, calcined diatomaceous earth, calcined barytes, calcined aluminum trihydrate, calcined pyrogenic silica, calcined titanium dioxide dehydrated kaolin, dehydrated calcium carbonate, dehydrated bentonites, dehydrated limestone, plastic, and combinations thereof. The amount of particulate materials in the composition can be from about 0.1 wt. % to about 5 wt. %, from about 5 wt. %, to about 10 wt. %, from about 10 wt. %, to about 25 wt. %, from about 25 wt. % to about 50 wt. %, or a range between and including any two of these values.

In some embodiments, the compositions include surfactants, dispersants, and combinations thereof. The amount of surfactants and/or dispersants in the composition can be from about 0.1 wt. % to about 5 wt. %, from about 5 wt. %, to about 10 wt. %, from about 10 wt. %, to about 25 wt. %, from about 25 wt. % to about 50 wt. %, or a range between and including any two of these values. Surfactants and dispersants include nonionic surfactants, anionic surfactants, cationic surfactants and/or amphoteric surfactants. Surfactants and dispersants can improve the quality of slurry compositions and help particulate materials to remain in solution during spraying. Surfactants and dispersants also function to break up agglomerates of particulate materials.

Suitable surfactants include alkali metal salts, alkaline earth metal salts and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, poly-oxyethylene octylphenol ether, ethoxylated isooctylphenol, octylphenol, nonylphenol, alkylphenyl polyglycol ether, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Suitable dispersants include lignosulfite waste liquors and methylcellulose.

In some embodiments, the compositions include wetting agents. The amount of surfactants and/or dispersants in the composition can be from about 0.1 wt. % to about 5 wt. %, from about 5 wt. %, to about 10 wt. %, from about 10 wt. %, to about 25 wt. %, from about 25 wt. % to about 50 wt. %, or a range between and including any two of these values. Wetting agents reduce surface tension of water in the slurry and thus increase the surface area over which a given amount of the slurry may be applied. Non limiting wetting agents include, for example, fatty acids and silanes. Fatty acids include fatty acids such as Hystreneo® or Industrene® products obtained from Witco Corporation or Emersol® products, including the stearic acid and stearate salts, obtained from Henkel Corporation. Silanes include the organofunctional silanes such as Silquest® products obtained from Witco or modified silicone fluids such as the DM-Fluids® obtained from Shin Etsu.

The compositions described herein can be formulated in a known manner, for example, by extending the artificially structured materials with the excipients, as described herein, including aqueous and/or organic liquids and/or particulate carriers.

The compositions described herein may be formulated as liquids, solids, or as solids suspended in liquids. In some embodiments, the artificially structured materials are ground into powder or granules before or after being added to one or more excipients described herein.

In some embodiments, the formulation includes water. The quantity of water may be suitable for the preparation of directly sprayable solutions. In some embodiments, the compositions described herein comprise an aqueous medium. In some embodiments, the composition comprises an aqueous carrier. Non-limiting examples of an aqueous medium include an aqueous liquid (e.g., fluid or solution), aqueous gel, or aqueous suspension. In some embodiments, the composition is an aqueous liquid. In some embodiments, the composition is an aqueous gel. In some embodiments, the composition is an aqueous suspension. The amount of aqueous medium in the composition can be from about 0.1 wt. % to about 5 wt. %, from about 5 wt. %, to about 10 wt. %, from about 10 wt. %, to about 25 wt. %, from about 25 wt. %, to about 50 wt. %, from about 50 wt. %, to about 75 wt. %, from about 75 wt. %, to about 99 wt. %, or a range between and including any two of these values.

Additional liquids (i.e., solvents) suitable for this purpose include those described herein, e.g., as organic liquids, such as aromatic solvents (e.g., xylene), paraffins (e.g., mineral oil fractions), alcohols (e.g., methanol, butanol, pentanol, benzyl alcohol), ketones (e.g., cyclohexanone, methyl hydroxybutyl ketone, diacetone alcohol, mesityl oxide, isophorone), lactones (e.g., gamma-butyrolactone), pyrrolidones (e.g., pyrrolidone, N-methylpyrrolidone, N-ethylpyrrolidone, n-octylpyrrolidone), acetates (glycol diacetate), glycols, dimethyl fatty acid amides, fatty acids and fatty acid esters. In principle, solvent mixtures may also be used.

Suitable for the preparation of directly sprayable solutions, are emulsions, pastes or oil dispersions that include water and/or one or more organic liquids such as methanol, ethanol, propanol, iso-propanol, iso-butanol, acetone, methyl ethyl ketone, ethylene oxide, propylene oxide, tetrahydrofuran, or combinations thereof. In some embodiments, the composition comprises a liquid carrier. Organic liquids can be added to the compositions described herein to form a slurry and this slurry can optionally be diluted with water to form an aqueous dispersion. The resulting slurry can retain the particulates of the compositions described herein in finely divided form. Typically, the organic liquids are used in an amount sufficient to form a dispersion of the compositions described herein. The amount of water and/or organic liquid in the composition can be from about 0.1 wt. % to about 5 wt. %, from about 5 wt. %, to about 10 wt. %, from about 10 wt. %, to about 25 wt. %, from about 25 wt. %, to about 50 wt. %, or a range between and including any two of these values.

Solid formulations for broadcasting and dusts can be prepared by mixing or jointly grinding the artificially structured materials with excipients, such as any of the solid carriers described herein. Thus, in some embodiments, the composition does not comprise a liquid carrier. Exemplary solid carriers include the particulate materials described herein such as ground natural minerals (e.g., kaolins, clays, talc, chalk) and ground synthetic minerals (e.g., finely divided silica, silicates). In some embodiments, the particles may be comprised of plastic or SiO₂. In some embodiments, the composition may comprise solid particles having a diameter of less than about 1,000 μm, 500 μm, 100 μm, 50 μm, 25 μm or 10 μm. In some embodiments, the composition may comprise solid particles having a diameter greater than 0.1 μm, 1 μm, or 10 μm.

Granules, for example coated granules, impregnated granules and homogeneous granules, can be prepared by binding the artificially structured materials with excipients, such as any of the solid carriers described herein. Exemplary solid carriers for the preparation of granules include, for example, mineral earths such as silica gels, silicates, talc, kaolin, atta-clay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and plant products such as chaff, cereal meal, tree bark meal, wood meal and nutshell meal, cellulose powder and other solid carriers.

In general, the compositions described herein can be formulated to include between 0.01 and 95% by weight, between 0.1 and 90% by weight, 1 to 50% by weight, 1 to 40% by weight, 1 to 30% by weight, 1 to 20% by weight, 1 to 10% by weight, 1 to 5% by weight, of the artificially structured materials.

In some embodiments, the composition is a coating. In other embodiments, the coating is a spray-on coating. In other embodiments, the composition is a coating for an organism capable of photosynthesis.

In an embodiment, the compositions described herein can be applied to a photosynthetically active organism, such as a plant, to regulate the amount and wavelengths of light that reach the surface of the organism. In some embodiments, the efficiency with which the sunlight that is not photosynthetically active is absorbed, reflected, emitted, or scattered by the composition is dependent upon at least one of: the temperature of the composition and the quantity of sunlight that contacts the composition.

In some embodiments, the composition absorbs incident light that is not photosynthetically active with an absorption coefficient that decreases as the temperature of the composition increases or the quantity of light increases. The absorption coefficient can be calculated from methods and according to equations that are known in the art. For example, the composition may absorb sunlight that is not photosynthetically active with an absorption coefficient that decreases from about 5% to about 10%, from about 10% to about 25%, from about 25% to about 50%, or a range between and including any two of these values, as quantity of light increases, for example, from morning until mid-day on clear day.

In some embodiments, the composition reflects light that is not photosynthetically active with a reflection coefficient that increases as the temperature of the composition increases or the quantity of incident light increases. The reflection coefficient can be calculated from methods and according to equations that are known in the art. For example, the composition may reflect sunlight that is not photosynthetcally active with a reflection coefficient that increases from about 5% to about 10%, from about 10% to about 25%, from about 25% to about 50%, or a range between and including any two of these values, as quantity of sunlight increases, for example, from morning until mid-day on clear day.

In some embodiments, the composition scatters incident light that is not photosynthetically active with a dissipation coefficient that increases as the temperature of the composition increases or the quantity of incident light increases. The dissipation coefficient can be calculated from methods and according to equations that are known in the art. For example, the composition may scatter sunlight that is not photosynthetically active with a dissipation coefficient that increases from about 5% to about 10%, from about 10% to about 25%, from about 25% to about 50%, or a range between and including any two of these values, as quantity of sunlight increases, for example, from morning until mid-day on clear day.

In some embodiments, the decrease or increase of optical properties of the composition occurs abruptly within a temperature range of about 5 degrees C., or 2 degrees C. In some embodiments, the decrease or increase occurs gradually within a temperature range of greater than about 10 degrees C. In some embodiments, the decrease or increase occurs gradually within a temperature range of greater than about 5 degrees C.

In an embodiment, incident light having wavelengths between 400-750 nm is substantially transmitted through the composition; and incident light having wavelengths that are not between 400-750 nm is at least partially absorbed, reflected, emitted, or scattered by the composition. In some embodiments, a fraction of sunlight having a wavelength of 400-750 nm is transmitted through the composition at any given temperature. In some embodiments, the fraction is from about 25% to about 50%, about 50% to about 75%, about 75% to about 99%, or a range between and including any two of these values. In some embodiments, the temperature is about 5° C., about 10° C., about 20° C., about 30° C., about 40° C., or a range between and including any two of these values.

In some embodiments, a fraction of sunlight having a wavelength between 300-400 nm, 750-1400 nm, or 1400-3000 nm is at least partially absorbed, reflected, or scattered by the composition at any given temperature. In some embodiments, the fraction is from about 25% to about 50%, about 50% to about 75%, about 75% to about 99%, or a range between and including any two of these values. In some embodiments, the temperature is about 20° C., about 30° C., about 40° C., or a range between and including any two of these values. In some embodiments, at least 80% of the sunlight having wavelengths between 750 nm-1400 nm is at least partially absorbed, reflected, or scattered by the composition at 27° C. In some embodiments, at least 80% of the sunlight having wavelengths between 1400-3000 nm is at least partially absorbed, reflected, or scattered by the composition at 27° C. In some embodiments, at least 80% of the sunlight having wavelengths between 300-400 nm is at least partially absorbed, reflected, or scattered by the composition at 27° C.

In some embodiments, the compounds and materials described herein absorb light that is not photosynthetically active and fluoresce light that is photosynthetically active. In some embodiments, incident light having wavelengths between 300-400 nm is at least partially absorbed by the composition and light having wavelengths between 400-750 nm is fluoresced by the composition. In some embodiments, optical downconversion, used to increase the efficiency of the compositions and materials described herein.

Optical downconversion converts ultraviolet (UV) light into visible light, which is used more efficiently by a solar cell. Similarly, UV light downconverted to visible light enhances photosynthetic activity in a photosynthetic organism.

In some embodiments, a coating comprised of a suitable excipient may contain nanoparticles of rare earth ions such that the coating will be transparent to visible light, allowing visible light to transmit to the organism's surface; concurrently, the incident UV wavelengths may be downconverted into the visible portion of the light spectrum, increasing the photosynthetically useable portion of light energy transmitting to the organism's surface. In some embodiments, coatings may utilize doping to increase the photosyntheticially active parts of the light spectrum for said photosynthetic organism.

Upconversion of incoming radiation from the infrared spectrum into the photosynthetically useful regime of the electromagnetic spectrum would be very valuable; for example, a higher than average percentage of incoming solar radiation is infrared light. In one embodiment, the compositions include lanthanide-doped NaYF4 nanocrystals (NCs), used successfully in the upconversion of long wavelength radiation into the visible regime. (See Nanoscale (2010) Vol. 2, Iss. 5, pp 771-7, The Royal Society of Chemistry.) Because these nanoparticles have been shown to be readily dissolvable in water, it is foreseeable that such particles may be useful in the compositions described herein such as photosynthetically enhancing upconverting coatings.

In some embodiments, the composition comprises an aqueous carrier. In some embodiments, the composition does not comprise a liquid or aqueous carrier. An example of such a composition is a powder format.

In some embodiments, the coating is a spray-on coating. Many antidessication coatings used in the plant industry are devised to be spray-on, either as solutions or as powder(s) mixed with water. Examples of commercial antidessicants that are applied as a spray include AntiStress, Shield Brite, and Moisturin. These coatings are sprayed onto an organism's surface, including a plant's body and roots.

In an embodiment, the organism is a plant. Most photosynthetic organisms are plants. Plants are defined to be green plants (Viridiplantae in Latin), organisms belonging to the kingdom, Plantae. Multicellular groups such as flowering plants, conifers, ferns and mosses, and, depending on the definition, green algae, are included in Viridiplantae. Fruits, vegetables, and grains are considered to be plants.

Green plant cell walls are comprised of cellulose, and characteristically receive most of their energy from light via photosynthesis, utilizing chlorophyll which are contained in chloroplasts and giving them a green color. In some cases, plants that cannot produce normal amounts of chlorophyll or photosynthesize may be parasitic. Red or brown seaweeds, such as kelp, and fungi and bacteria are not included in Viridiplantae.

In an embodiment, the plant produces soybean, corn, wheat, barley, oats, rye, rape, millet, rice, sunflower, cotton, sugar beets, bananas, strawberries, blueberries, almonds, grapes, mango, papaya, peanuts, potatoes, tomatoes, peppers, cucurbits, cucumbers, melons, watermelons, garlic, onions, carrots, cabbage, beans, peas, lentils, alfalfa, trefoil, lotus, clovers, flax, herb, grass, lotus, lettuce, sugar cane, citrus, apples, tea, tobacco, coffee, or adornment, and plants produced for floriculture, such as roses.

In an embodiment, the plant is a tree. Such trees include those produced for floriculture and ornamentation, for reforestation, for fuels, for soaps, perfume, furniture, and for feedstuff and feedstock. Examples of trees used for fuel include poplar, oak, pine and eucalyptus. Examples of trees used for their flower petals, leaves, bark, wood, seeds, roots, fruit rind, gums, and resins include sandalwood and ylang-ylang. Examples of trees used for reforestation, furniture and building materials include oak, pine and redwood

In an embodiment, the coated composition adheres to the organism. Possible excipients that would also serve as adherents proven non-harmful to plants and used in field trials are wax, acrylic polymers, and latex emulsions, among others. These may also act as antidesicants. See, e.g., J. M. Englert, et al., “Antidesiccant Compounds Improve the Survival of Bare-root Deciduous Nursery Trees” J. Amer. Soc. Hort. Sci. 118(2):228-235. 1993.

In an embodiment, the coated composition is permeable to gas transfer between the organism and the atmosphere. Coating materials used to preserve fruit, such as those described in U.S. Pat. No. 4,021,262, for example, are permeable.

In an embodiment, the algae produces a feedstuff or feedstock, such as biofuel.

In another embodiment, the algae are halophyte algae (algae that grow in saltwater. In an embodiment, the algae produces a fuel. An example is algae as a feedstock. More fuel per acre may be produced with algae than through ethanol crops like corn. Halophytes as a petrochemical may also be used to make plastic. Algae are a renewable and CO₂-neutral power source.

In some embodiments, the organism is a plant. In some embodiments, the plant is grown on a farm, orchard, or in a forest. In some embodiments, the plant produces a grain, fruit, vegetable, feedstuff, or feedstock. In some embodiments, the plant produces soybean, corn, wheat, barley, oats, rye, rape, millet, rice, sunflower, cotton, sugar beets, bananas, strawberries, blueberries, almonds, grapes, mango, papaya, peanuts, potatoes, tomatoes, peppers, cucurbits, cucumbers, melons, watermelons, garlic, onions, carrots, cabbage, beans, peas, lentils, alfalfa, trefoil, clovers, flax, herb, grass, lotus, lettuce, sugar cane, tea, tobacco, coffee, or an adornment, or floriculture. In some embodiments, the plant is a tree. In an embodiment, the plant is grown on a farm, in a pond, on or in a body of water, in an orchard, or in a forest. An example of a plant raised in a pond or in or on body of water is lotus.

In another aspect an article is provided, wherein the article comprises an organism capable of photosynthesis and a composition, wherein the composition coats at least a portion of the organism's photosynthetically active surface and the composition comprises: an artificially structured material and an excipient; wherein incident light that is photosynthetically active is at least partially transmitted through the composition; and incident light that is not photosynthetically active is at least partially absorbed, reflected, emitted, or scattered by the composition.

In some embodiments of the article, reflection occurs primarily at the surface of the coated composition. In some embodiments of the article, reflection occurs primarily by volumetric scattering throughout the coated composition.

In some embodiments of the article, the coated composition adheres to the organism. In other embodiments, the coated composition is permeable to gas transfer between the organism and the atmosphere. In other embodiments, the coated composition regulates the temperature of the organism. In other embodiments, the coated composition cools the organism by at least 5%. In other embodiments, the coated composition is transparent to substantially all light of 400-750 nm and the coating absorbs or reflects portions of light of 300 nm-400 nm and 750 nm-3000 nm. In other embodiments, the coated composition reflects increasing quantities of light or absorbs decreasing quantities of light upon exposure to increasing temperatures. In other embodiments, the coated composition reflects decreasing quantities of light or absorbs increasing quantities of light upon exposure to decreasing temperatures.

In some embodiments of the article, upon exposure to decreasing temperatures, the coated composition increases the quantity of light of 300 nm-400 nm that is absorbed or decreases the quantity of light of 300 nm-400 nm that is reflected. In other embodiments, upon exposure to increasing temperatures, the coated composition decreases the quantity of light of 300 nm-400 nm that is absorbed or increases the quantity of light of 300 nm-400 nm that is reflected. In other embodiments, upon exposure to decreasing temperatures, the coated composition increases the quantity of light of 750 nm-1400 nm that is absorbed or decreases the quantity of light of 750 nm-1400 nm that is reflected. In other embodiments, upon exposure to increasing temperatures, the coated composition decreases the quantity of light of 750 nm-1400 nm that is absorbed or increases the quantity of light of 750 nm-1400 nm that is reflected. In other embodiments, the coated composition absorbs light of 750 nm-1400 nm and fluoresces light of 400-750 nm.

In some embodiments of the article, the organism is any one or more of the organisms described herein.

In another aspect, a method is provided for growing an organism capable of photosynthesis, the method comprising coating at least a portion of the organism's photosynthetically active surface with a composition, wherein the composition comprises an artificially structured material and an excipient; wherein incident light that is photosynthetically active is at least partially transmitted through the composition; and incident light that is not photosynthetically active is at least partially absorbed, reflected, emitted, or scattered by the composition.

In some embodiments of the method, upon exposure to decreasing temperatures, the coated composition increases the quantity of light of 1400 nm-3000 nm that is absorbed or decreases the quantity of light of 1400 nm-3000 nm that is reflected. In other embodiments, upon exposure to increasing temperatures, the coated composition decreases the quantity of light of 1400 nm-3000 nm that is absorbed or increases the quantity of light of 1400 nm-3000 nm that is reflected.

In some embodiments of the method, reflection occurs primarily at the surface of the coated composition. In other embodiments, reflection occurs primarily by volumetric scattering throughout the coated composition.

In some embodiments of the method, the coating step is performed at least once per year. In other embodiments, the coating step is performed at least once per month. In other embodiments, the coating step is performed at least once per week. In other embodiments, the coating step is preceded by the application of an adhesive to the organism to promote adhesion of the composition to the organism.

The amount of the composition to be applied can and will vary depending upon a number of factors including the manner of application, the identity of the plant, the amount of plants per hectare and the concentration of the composition. The quantity of composition applied may be from about 0.1 kg per hectare to about 1 kg per hectare, from about 1 kg per hectare to about 10 kg per hectare, from about 10 kg per hectare to about 100 kg per hectare, or a range between and including any two of these values. In some embodiments, the composition is coated with an application-density of at least about 1 kg per hectare.

In some embodiments of the method, the plant's rate of photosynthesis is intended to be increased following the coating step by about 5% to about 10%, about 10% to about 20%, about 20% to about 30%, about 30% to about 40%, about 40% to about 60%, about 60% to about 80%, about 80% to at least about 100%, or a range between and including any two of these values, after the initial coating step, during a period of time of from about one day to about one week, from about one week to about one month, from about six months to about one year, from about one year to about five years, or a range between and including any two of these values.

In some embodiments of the method, the plant's rate of growth is intended to be increased following the coating step by about 5% to about 10%, about 10% to about 20%, about 20% to about 30%, about 30% to about 40%, about 40% to about 60%, about 60% to about 80%, about 80% to at least about 100%, or a range between and including any two of these values, after the initial coating step, during a period of time of from about one day to about one week, from about one week to about one month, from about six months to about one year, from about one year to about five years, or a range between and including any two of these values.

In some embodiments of the method, the amount of water consumed by the plant following the coating step is intended to be reduced by about 5% to about 10%, about 10% to about 20%, about 20% to about 30%, about 30% to about 40%, about 40% to about 60%, about 60% to about 80%, or a range between and including any two of these values, after the initial coating step, during a period of time of from about one day to about one week, from about one week to about one month, from about six months to about one year, from about one year to about five years, or a range between and including any two of these values.

In some embodiments of the method, the plant's temperature following the coating step is intended to be reduced by about 5% to about 10%, about 10% to about 20%, about 20% to about 30%, about 30% to about 40%, or a range between and including any two of these values, after the initial coating step, during a period of time of from about one day to about one week, from about one week to about one month, from about six months to about one year, from about one year to about five years, or a range between and including any two of these values. In some embodiments of the method, the plant's temperature is intended to be reduced by about 0.5 degree Celsius to 1 degree Celsius, 1 degree Celsius to 2 degrees Celsius, 2 degrees Celsius to 3 degrees Celsius, 3 degrees Celsius to 5 degrees Celsius, 5 degrees Celsius to 10 degrees Celsius, 10 degrees Celsius to 30 degrees Celsius.

In an embodiment of the method, a user can detect a change in at least one attribute of the organism after the initial coating step, and perform a second coating step based on the change. The attribute can comprise at least one of an optical reflectivity, a thermal radiation emission, a temperature, a water usage, a growth rate, a size, and a photosynthesis rate. The method further comprises detecting the presence and amount of the coating on the organism.

In an additional embodiment of the method, the coated composition enhances photosynthesis in the organism. In an additional embodiment of the method, the coated composition reduces photodamage to the organism. In some embodiments of the method, the coated composition absorbs incident near-UV photons in a radiationless mode. In some embodiments of the method, the coated composition allows gas transfer into or out of the organism's surface. In some embodiments of the method, wherein the coated composition reduces thermoaquatic stress to the organism. In some embodiments of the method, the coated composition absorbs incident near-UV photons and fluoresces light at a photosynthetically active spectral band. In some embodiments of the method, the coated composition scatters or fluoresces near-infrared (NIR) photons. In some embodiments of the method, the coated composition absorbs incident low-infrared non-reflected light. In some embodiments of the method, the coated composition modifies near infrared absorption over a normal value for the organism. In some embodiments of the method, the coated composition reflects incident light from a surface of the coated composition or disperses incident light by volumetric scattering within the coated composition.

In some embodiments of the method, coated composition comprises at least one optical property that is temperature sensitive. In some embodiments of the method, the coated composition reduces stress on the organism. In some embodiments of the method, the coated composition protects the organism from heat. In some embodiments of the method, the coated composition comprises an optical chaff that cools the organism. In some embodiments of the method, the coated composition increases thermal emissivity of long-wave infrared radiation from the organism.

In some embodiments of the method, the coated composition comprises an artificially structured material. In some embodiments of the method, the artificially structured material is radiation flux-sensitive. In some embodiments of the method, the artificially structured material thermostats the surface temperature of the organism. In some embodiments of the method, the artificially structured material preferentially absorbs light which is not photosynthetically active at a temperature, and scatters or fluoresces such light at a higher relative temperature. In some embodiments of the method, the artificially structured material modifies the emissivity of long-wave infrared radiation from the organism. In some embodiments of the method, the artificially structured material has radiative properties that change during the day.

In some embodiments of the method, the organism is any one or more of the organisms described herein.

The present technology, thus generally described, will be understood more readily by reference to the following Examples, which are provided by way of illustration and is not intended to be limiting of the present technology.

### EXAMPLES

### Example 1

### Concentrated Formulations of Artificially Structured Materials

Aqueous Suspension:

10 parts by weight of artificially structured materials are ground (e.g., in a rotor-stator mill) and suspended in 88 parts by weight of water or a water-soluble solvent and 2 parts by weight of an adhesive. Alternatively, additional excipients are added. The formulation contains 10% by weight of artificially structured materials suspended in an aqueous solution.

Emulsifiable Suspension:

15 parts by weight of artificially structured materials are ground and suspended in 73 parts by weight of xylene and 2 parts by weight of an adhesive with the addition of calcium dodecylbenzenesulfonate and castor oil ethoxylate (in each case 5 parts by weight). The formulation includes 15% by weight of artificially structured materials. Upon dilution in water, an emulsified suspension of artificially structured material results.

Dusts:

5 parts by weight of artificially structured materials are ground and 1 part by weight of an adhesive are mixed with 94 parts by weight of finely particulate kaolin. This gives a dust with 5% by weight of artificially structured materials.

### Example 2

### Use of the Compositions Described Herein to Increase Crop Yields and Decrease the Volume of Water Used for Irrigation

(A) The aqueous suspension described in Example 1 is diluted and sprayed on one hundred apple trees (“treated trees”) in an amount of approximately 1 kg per hectare, with a frequency of about one application per month, during a growing season. One hundred apple trees of the same variety, in the same orchard, are not treated with a composition as described herein (“control trees”). The apples from all two hundred trees are harvested at the end of the growing season and the number of apples harvested from the treated trees is compared to the number of apples harvested from the control trees.

(B) The aqueous suspension described in Example 1 is diluted and sprayed on one hundred acres of corn (“treated corn field”) in an amount of approximately 1 kg per hectare, with a frequency of about one application per month, during the growing season. One hundred acres of corn of the same variety, in an adjacent plot, are not treated with a composition as described herein (“control corn field”). The treated corn field is irrigated with 20% less water than the control corn field. Corn from all two hundred acres is harvested at the end of the growing season and the amount of corn harvested from the treated corn field is compared with the amount of corn harvested from the control corn field.

The compositions described herein help regulate the quantity and wavelengths of light that reach crops. By channeling a greater quantity of sunlight that is photosynthetically active to the surface of the crop, the compositions described herein can be used to maintain or bolster the photosynthetic capacity and quality of crops and increase agricultural yields. The compositions described herein can also be used to reduce the volume of water necessary to irrigate crops and improve the drought-resistance of the crops.

### EQUIVALENTS

The embodiments, illustratively described herein may suitably be practiced in the absence of any element or elements, limitation or limitations, not specifically disclosed herein. Thus, for example, the terms ‘comprising,’ ‘including,’ ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. A composition comprising an artificially structured material and an excipient, wherein the composition is a coating for an organism capable of photosynthesis; and
incident light that is photosynthetically active is at least partially transmitted through the composition; and
incident light that is not photosynthetically active is at least partially absorbed, reflected, emitted, or scattered by the composition.

2. The composition of claim 1, wherein the coating is configured to enhance the organism's rate of photosynthesis.

3. The composition of claim 1, wherein the coating is configured to reduce photodamage to the organism.

4. The composition of claim 1, wherein the coating is configured to absorb incident near-UV photons in a radiationless mode.

5. The composition of claim 1, wherein the coating allows gas transfer into or out through the organism's surface.

6. The composition of claim 1, wherein the coating is configured to reduce thermoaquatic stress to the organism.

7. The composition of claim 1, wherein the coating is configured to absorb incident near-UV photons and fluoresce light that is photosynthetically active.

8. The composition of claim 1, wherein the coating is configured to scatter or fluoresce near-infrared (NIR) photons.

9. The composition of claim 1, wherein the coating is configured to absorb incident low-infrared non-reflected light.

10. The composition of claim 1, wherein the coating is configured to modify NIR absorption over a normal value for the organism.

11. The composition of claim 1, wherein the coating is configured to reflect incident light from a surface of the coating and/or by volumetric scattering within the coating.

12. The composition of claim 1, wherein the coating comprises at least one optical property that is temperature sensitive.

13. The composition of claim 1, wherein the coating is configured to thermostat the organism's surface temperature.

14. The composition of claim 1, wherein the coating is configured to absorb light that is not photosynthetically active at one temperature, and scatter or fluoresce light that is not photosynthetically active at a higher temperature.

15. The composition of claim 1, wherein the coating is configured to reflect or scatter an increasing proportion of light that is not photosynthetically active as the temperature of the coating increases and absorb a decreasing proportion of light that is not photosynthetically active as the temperature of the coating increases.

16. The composition of claim 1 wherein the coating is configured to protect the organism from heat related damage or stress.

17. The composition of claim 1, wherein the coating comprises an optical chaff that is configured to increase radiative cooling of the organism.

18. The composition of claim 1, wherein the coating is configured to increase thermal emissivity in the LWIR above the normal value for the organism.

19. The composition of claim 1, wherein the artificially-structured material is configured to modify LWIR emissivity over the normal value of the organism.

20. The composition of claim 1, wherein the artificially structured material is radiation flux-sensitive.

21. The composition of claim 1, wherein the artificially-structured material comprises radiative properties that change during the day.

22. The composition of claim 1, wherein the artificially structured material comprises at least one of a metamaterial, multilayer dielectric (MLD)-type reflector, photonic bandgap (PBG) material, liquid crystal, semiconductor, photochromic dye, leuco dye, radiatively active material, or a combination thereof.

23-43. (canceled)

44. The composition of claim 1, comprising two or more artificially structured materials.

45. The composition of claim 1, wherein the excipient is selected from the group consisting of an adhesive agent, fungicide, antibiotic, pesticide, plant nutrient, antifreeze agent, particulate material, surfactant, dispersant, a wetting agent, a marking agent, and a combination thereof.

46. The composition of claim 1, wherein the efficiency with which the incident light that is not photosynthetically active is absorbed, reflected, emitted, or scattered by the composition is dependent upon at least one of: the temperature of the composition and the quantity of incident light that contacts the composition.

47. The composition of claim 1, wherein the composition absorbs incident light that is not photosynthetically active with an absorption coefficient that decreases as the temperature of the composition increases or the quantity of light increases.

48. The composition of claim 1, wherein the composition reflects light that is not photosynthetically active with a reflection coefficient that increases as the temperature of the composition increases or the quantity of incident light increases.

49. The composition of claim 1, wherein the composition scatters incident light that is not photosynthetically active with a dissipation coefficient that increases as the temperature of the composition increases or the quantity of incident light increases.

50. (canceled)

51. (canceled)

52. The composition of claim 1, wherein incident light having wavelengths between 400-750 nm is substantially transmitted through the composition; and incident light having wavelengths that are not between 400-750 nm is at least partially absorbed, reflected, emitted, or scattered by the composition.

53-56. (canceled)

57. The composition of claim 1, wherein incident light having wavelengths between 300-400 nm is at least partially absorbed by the composition and light having wavelengths between 400-750 nm is fluoresced by the composition.

58. The composition of claim 1, wherein the composition comprises solid particles.

59-64. (canceled)

65. The composition of claim 1, wherein the coating is a spray-on coating.

66. The composition of claim 1, wherein the organism comprises algae.

67. (canceled)

68. (canceled)

69. The composition of claim 1, wherein the organism is a plant.

70-72. (canceled)

73. The composition of claim 69, wherein the plant is a tree.

74-131. (canceled)
